(19) United States
(12) Patent Application Publication
(10) Pub. No.: US 2020/0013331 A1
(43) Pub. Date: Jan. 9, 2020

(54) DISPLAY DEVICE AND DRIVING METHOD OF DISPLAY DEVICE

(71) Applicant: Sharp Kabushiki Kaisha, Sakai City, Osaka (JP)

(72) Inventor: Fumiyuki KOBAYASHI, Sakai City (JP)

(21) Appl. No.: 16/468,081

(22) PCT Filed: Sep. 14, 2017
(86) PCT No.: PCT/JP2017/033216

§ 371 Date: Jun. 10, 2019

(51) Int. Cl. G09G 3/3233; G09G 3/3275; G09G 3/3266

(52) U.S. Cl. CPC G09G 3/3233; G09G 2300/0439; G09G 3/3266; G09G 3/3275

(57) ABSTRACT

The disclosure has an object to suppress reduction in display quality due to insufficient charge in a display device adopting a Source Shared Driving (SSD) method.

A display device includes a demultiplexer portion including switches. Three switches are provided for each of output portions of a source driver to enable a data signal to be distributed to three data lines. In display of a moving picture, a driving frequency is set to a frequency higher than a driving frequency in display of a still picture, and the three switches are simultaneously turned to an ON state in each of horizontal scan periods. In display of a still picture, the driving frequency is set to a frequency lower than the driving frequency in display of a moving picture is performed, and the three switches are sequentially turned to an ON state at predetermined intervals in each of the horizontal scan periods.

### TECHNICAL FIELD

The following disclosure relates to a display device such as an organic EL display device, and a driving method of the display device.

### BACKGROUND ART

In recent years, organic EL display devices including pixel circuits including organic Electro Luminescence elements (hereinafter referred to as “organic EL elements”) have been coming into practical use. The organic EL element is a self-luminous display element that emits light with luminance according to an amount of an electric current flowing through the organic EL element. Such an organic EL display device using the organic EL elements being self-luminous display elements can be easily thinned, reduced in power consumption, and increased in luminance, and the like, as compared with a liquid crystal display device requiring backlights, color filters, and the like.

A pixel circuit of the organic EL display device includes a driving transistor, a writing control transistor, and a holding capacitor, and the like, in addition to the organic EL element. As the driving transistor and the writing control transistor, thin film transistors (TFTs) are used in general. The holding capacitor is connected with a gate terminal serving as a control terminal of the driving transistor. A voltage according to a data signal (an image signal) representing an image to be displayed is applied to the holding capacitor via a data line. The driving transistor is provided in series with the organic EL element, and controls an amount of an electric current flowing through the organic EL element according to the voltage held in the holding capacitor.

Incidentally, in recent years, technology of enhancing a resolution has been remarkable in display devices such as the above-mentioned organic EL display device. As the technology of enhancing a resolution advances, the number of pixels is increased, and accordingly the number of data lines to be arranged in a frame region (a region other than a display portion) is increased. As a result, the frame region is required to be widened, and thus downsizing of the display device is hindered.

In view of this, as a driving method for reducing the number of data lines to be arranged in the frame region, a driving method has been proposed. In the driving method, switches (typically, TFTs) are provided in the frame region, and an output (i.e., a data signal) from a source driver (a data line drive circuit) is shared by multiple data lines. This driving method is referred to as an “SSD method”. Note that the “SSD” stands for “Source Shared Driving”.

FIG. 10 is a diagram for describing a known SSD method. In FIG. 10, each red subpixel is designated by a reference sign 90(R), each green subpixel is designated by a reference sign 90(G), and each blue subpixel is designated by a reference sign 90(B). In a known display device adopting the SSD method, as illustrated in FIG. 10, a demultiplexer portion 92 for distributing each of data signals D to multiple (in this example, three) data lines is provided between a display portion 900 and a source driver 91. In the example illustrated in FIG. 10, the demultiplexer portion 92 includes a switch 93(R) for controlling a state of electrical connection between an output portion 911 that outputs the data signals D and a data line for red D(R), a switch 93(G) for controlling a state of electrical connection between the output portion 911 and a data line for green D(G), and a switch 93(B) for controlling a state of electrical connection between the output portion 911 and a data line for blue D(B). In such a configuration, in each of horizontal scan periods, the switch 93(R), the switch 93(G), and the switch 93(B) are sequentially turned to an ON state at predetermined intervals. Consequently, in each horizontal scan period, the data signals are sequentially supplied to the data line for red D(R), the data line for green D(G), and the data line for blue D(B). Then, data is written to the red subpixel 90(R), the green subpixel 90(G), and the blue subpixel 90(B) while the data line for red D(R), the data line for green D(G), and the data line for blue D(B) are charged based on the data signals. Based on such writing, an image is displayed in the display portion 900. According to adoption of such an SSD method as described above, the number of data lines to be arranged in the frame region is reduced, and thus extension of the frame region can be suppressed even with advanced technology of enhancing a resolution. Note that an invention relating to an organic EL display device adopting the SSD method is disclosed in JP 2013-190526 A, for example.

### CITATION LIST

### Patent Literature

PTL 1: JP 2013-190526 A

### SUMMARY

### Technical Problem

However, in a case where the SSD method is adopted, data signals need to be supplied from each output portion of the source driver to multiple data lines in one horizontal scan period. Therefore, charge time for each data line is reduced. Consequently, the data lines may not be sufficiently charged in some cases. In such cases, a magnitude of a charged voltage of the holding capacitors in the pixel circuits is insufficient. As a result, a desired drive current is not supplied to the organic EL elements, and thus display quality is reduced.

In view of this, the following disclosure has an object to suppress reduction in display quality due to insufficient charge in a display device adopting an SSD method.

### Solution to Problem

A display device according to some embodiments of the disclosure is a display device including a display portion including multiple pixels, each of the multiple pixels including K (K being an integer equal to or greater than 3) subpixels of basic colors, the display device including:

multiple data lines arranged in the display portion, the multiple data lines being configured to supply data signals to the subpixels;

a data line drive circuit configured to drive the multiple data lines by outputting the data signals;

a data signal distribution portion including switches, K switches of the switches being provided for each of output portions of the data line drive circuit, the K switches being configured to control a state of electrical connection between each of the output portions and each of K data lines of the multiple data lines associated with each of the output portions, each of the output portions of the data line drive circuit being associated with the K data lines to enable each of the data signals output from the data line drive circuit to be distributed to the K data lines;

a switch controller configured to control states of the switches included in the data signal distribution portion; and

a driving frequency setting portion configured to set a driving frequency depending on whether an image to be displayed in the display portion is a moving picture or a still picture,

wherein, in a case where the image to be displayed in the display portion is a still picture, the driving frequency setting portion sets the driving frequency to a frequency lower than a frequency when the image to be displayed in the display portion is a moving picture,

the switch controller

simultaneously turns the K switches to an ON state in each of horizontal scan periods in a case where the image to be displayed in the display portion is a moving picture, and

sequentially turns the K switches to an ON state at predetermined intervals in each of the horizontal scan periods in the case where the image to be displayed in the display portion is a still picture.

### Advantageous Effects of Disclosure

According to some embodiments of the disclosure, in the display device adopting the SSD method, the driving frequency and the operation of the switches in the data signal distribution portion for implementing the SSD method are different between a case that display of a moving picture is performed and a case that display of a still picture is performed. To be more specific, in the case that display of a moving picture is performed, the driving frequency is set to a frequency higher than the driving frequency in the case that display of a still picture is performed, and the K switches corresponding to each of the output portions of the data line drive circuit are simultaneously turned to an ON state in each of the horizontal scan periods. As described above, the K switches corresponding to each of the output portions are simultaneously turned to an ON state in each of the horizontal scan periods, instead of being sequentially turned to an ON state in each of the horizontal scan periods. Accordingly, although the resolution is lowered, charge time for each of the data lines is sufficiently secured even with a high driving frequency. In the case that display of a still picture is performed, the driving frequency is set to a frequency lower than the driving frequency in the case that display of a moving picture is performed, and the K switches corresponding to each of the output portions of the data line drive circuit are sequentially turned to an ON state at intervals of a predetermined period. Since the driving frequency is set to be low as described above, charge time for each of the data lines is sufficiently secured even when the K data lines corresponding to each of the output portions are sequentially charged in each of the horizontal scan periods. As described above, charge time for each of the data lines is sufficiently secured both in the case that display of a moving picture is performed and the case that display of a still picture is performed. As a result, reduction in display quality due to insufficient charge is suppressed.

### BRIEF DESCRIPTION OF DRAWINGS

FIG. 1 is a diagram for describing an outline of a driving method of an organic EL display device according to an embodiment.

FIG. 2 is a block diagram illustrating an entire configuration of the organic EL display device according to the above embodiment.

FIG. 3 is a circuit diagram illustrating a configuration of a pixel circuit corresponding to a certain column of an n-th row in the above embodiment.

FIG. 4 is a timing chart for describing a driving method of the pixel circuit corresponding to the certain column of the n-th row (the pixel circuit illustrated in FIG. 3) according to the above embodiment.

FIG. 5 is a circuit diagram for describing a specific configuration of a demultiplexer portion according to the above embodiment.

FIG. 6 is a diagram for describing constituent elements provided in a display control circuit according to the above embodiment.

FIG. 7 is a timing chart for describing a driving method in a case of display of a moving picture according to the above embodiment.

FIG. 8 is a timing chart for describing a driving method in a case of display of a still picture according to the above embodiment.

FIG. 9 is a diagram for describing a difference in resolutions between the case of display of a moving picture and the case of display of a still picture according to the above embodiment.

FIG. 10 is a diagram for describing a known SSD method.

### DESCRIPTION OF EMBODIMENTS

An embodiment will be described below with reference to the accompanying drawings. Note that the following description is based on the premise that i and j each represent an integer equal to or greater than 2, and n represents an integer from 1 to j.

### 1. Entire Configuration

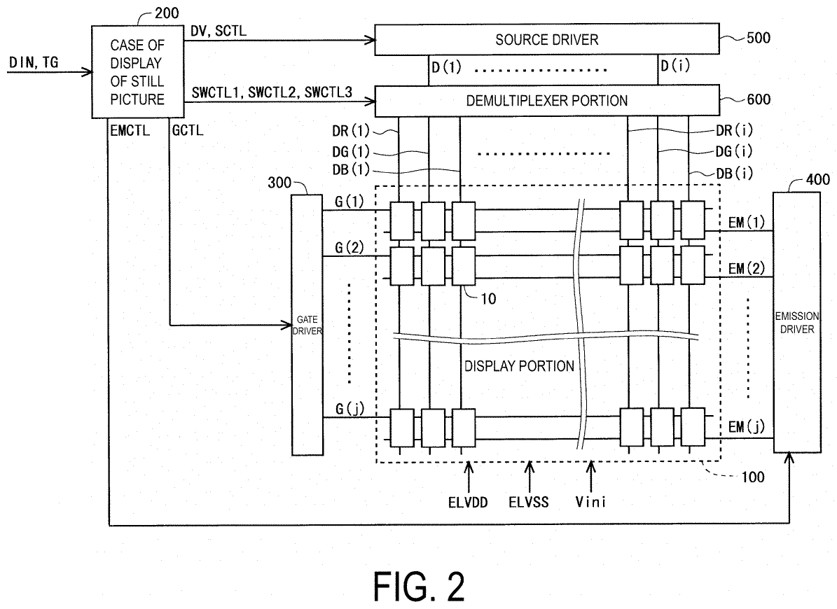

FIG. 2 is a block diagram illustrating an entire configuration of an organic EL display device according to an embodiment. As illustrated in FIG. 2, the organic EL display device includes a display portion 100, a display control circuit 200, a gate driver 300, an emission driver 400, a source driver 500, and a demultiplexer portion 600. The organic EL display device is a display device that adopts an SSD method, in which data signals are supplied from the source driver 500 to data lines via the demultiplexer portion 600. The gate driver 300 and the emission driver 400 are typically formed integrally with the display portion 100. Note that the organic EL display device performs color display achieved by three primary colors. In other words, red, green, and blue are used as basic colors, and display of colors obtained by mixing these basic colors is performed.

In the display portion 100, (i×3) data lines DR(1) to DR(i), DG(1) to DG(i), and DB(1) to DB(i), and j scanning signal lines G(1) to G(j) orthogonal to these data lines are arranged. In the display portion 100, j light emission control lines EM(1) to EM(j) are arranged to correspond to the j scanning signal lines G(1) to G(j) on a one-to-one basis. The scanning signal lines G(1) to G(j) and the light emission control lines EM(1) to EM(j) are typically parallel to each other. Further, the display portion 100 is provided with (i×3×j) pixel circuits 10 to correspond to intersections between the (i×3) data lines DR(1) to DR(i), DG(1) to DG(i), and DB(1) to DB(i), and the j scanning signal lines G(1) to G(j). One pixel circuit 10 forms one subpixel. The data lines DR(1) to DR(i) are connected with the pixel circuits 10 that form red subpixels, the data lines DG(1) to DG(i) are connected with the pixel circuits 10 that form green subpixels, and the data lines DB(1) to DB(i) are connected with the pixel circuits 10 that form blue subpixels. In the following description, as necessary, scanning signals applied to the j scanning signal lines G(1) to G(j) are also designated by the reference signs G(1) to G(j), and light emission control signals applied to the j light emission control lines EM(1) to EM(j) are also designated by the reference signs EM(1) to EM(j).

In the display portion 100, power source lines (not illustrated) which are common to the pixel circuits 10 are also arranged. To be more specific, a power source line which supplies a high level power source voltage ELVDD for driving organic EL elements (hereinafter referred to as a “high level power source line”), a power source line which supplies a low level power source voltage ELVSS for driving the organic EL elements (hereinafter referred to as a “low level power source line”), and a power source line which supplies an initialization voltage Vini (hereinafter referred to as an “initialization power source line”) are arranged. The high level power source voltage ELVDD, the low level power source voltage ELVSS, and the initialization voltage Vini are supplied from a power source circuit (not illustrated).

Operations of the components illustrated in FIG. 2 will be described below. The display control circuit 200 receives an input image signal DIN and a timing signal group (a horizontal synchronization signal, a vertical synchronization signal, and the like) TG that are transmitted from the outside. The display control circuit 200 outputs a digital image signal DV, a gate control signal GCTL for controlling the operation of the gate driver 300, an emission driver control signal EMCTL for controlling the operation of the emission driver 400, a source control signal SCTL for controlling the operation of the source driver 500, and first to third switch control signals SWCTL1 to SWCTL3 for controlling states of switches described later that are provided in the demultiplexer portion 600. The gate control signal GCTL includes a gate start pulse signal, a gate clock signal, and the like. The emission driver control signal EMCTL includes an emission start pulse signal, an emission clock signal, and the like. The source control signal SCTL includes a source start pulse signal, a source clock signal, a latch strobe signal, and the like.

The gate driver 300 is connected with the j scanning signal lines G(1) to G(j). The gate driver 300 applies scanning signals to the j scanning signal lines G(1) to G(j), based on the gate control signal GCTL output from the display control circuit 200.

The emission driver 400 is connected with the j light emission control lines EM(1) to EM(j). The emission driver 400 applies light emission control signals to the j light emission control lines EM(1) to EM(j), based on the emission driver control signal EMCTL output from the display control circuit 200.

The source driver 500 includes an i-bit shift register, a sampling circuit, a latch circuit, i D/A converters, and the like, which are not illustrated. The shift register includes i registers connected with each other in a cascade manner. The shift register sequentially transfers a pulse of a source start pulse signal supplied to a first stage register from an input terminal to an output terminal based on the source clock signal. In response to this pulse transferring, sampling pulses are output from respective stages of the shift register. The sampling circuit stores the digital image signal DV based on the sampling pulses. The latch circuit acquires and holds the digital image signal DV for one row stored in the sampling circuit in accordance with the latch strobe signal. The D/A converters are provided to correspond to respective output lines D(1) to D(i). The D/A converters convert the digital image signal DV held by the latch circuit into analog voltages. The converted analog voltages are simultaneously applied as data signals to all of the output lines D(1) to D(i). In the present embodiment, three output lines form one output line group. Regarding each output line group, a data signal for red is applied to the first output line, a data signal for green is applied to the second output line, and a data signal for blue is applied to the third output line. Those data signals are supplied to the data lines via the demultiplexer portion 600. As described above, the source driver 500 applies data signals to the (i×3) data lines DR(1) to DR(i), DG(1) to DG(i), and DB(1) to DB(i) via the demultiplexer portion 600.

The demultiplexer portion 600 includes i input terminals and (i×3) output terminals. In other words, three output terminals are provided for each input terminal. The input terminal is connected with the output terminals, and the output terminals are connected with the data lines. The first to third switch control signals SWCTL1 to SWCTL3 for controlling states of internal switches are applied to the demultiplexer portion 600. With this configuration, the demultiplexer portion 600 distributes data signals applied from one output line to three data lines, based on the first to third switch control signals SWCTL1 to SWCTL3. The present embodiment adopts the SSD method as described above, and thus the number of output lines connected with the source driver 500 can be reduced to one third of the number of output lines of a case not adopting the SSD method. Consequently, a frame region can be narrowed. A circuit scale of the source driver 500 is reduced, and therefore a manufacturing cost of the source driver 500 can be reduced. Note that further detailed description of the demultiplexer portion 600 will be given later. The first to third switch control signals SWCTL1 to SWCTL3 are also hereinafter collectively referred simply as a “switch control signal”.

As in a manner described above, the data signals are applied to the (i×3) data lines DR(1) to DR(i), DG(1) to DG(i), and DB(1) to DB(i), the scanning signals are applied to the j scanning signal lines G(1) to G(j), and the light emission control signals are applied to the j light emission control lines EM(1) to EM(j). Consequently, an image based on the input image signal DIN is displayed in the display portion 100.

### 2. Pixel Circuit

### 2.1 Configuration of Pixel Circuit

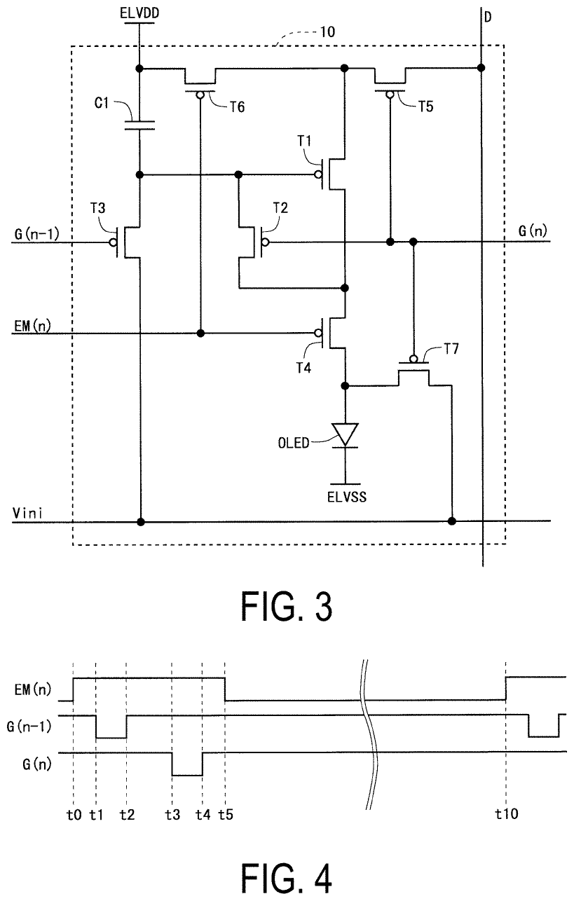

Next, a configuration of the pixel circuit 10 in the display portion 100 will be described. Note that the configuration of the pixel circuit 10 illustrated herein is merely an example, and the configuration is not limited thereto. FIG. 3 is a circuit diagram illustrating the configuration of the pixel circuit 10 corresponding to a certain column of an n-th row. The pixel circuit 10 illustrated in FIG. 3 includes one drive transistor organic EL element OLED, seven transistors T1 to T7 (a driving transistor T1, a threshold voltage compensation transistor T2, an initialization transistor T3, a light emission control transistor T4, a writing control transistor T5, a power supply control transistor T6, and an anode control transistor T7), and one holding capacitor C1. The transistors T1 to T7 are p-channel thin film transistors. The holding capacitor C1 is a capacitance element including two electrodes (a first electrode and a second electrode).

Note that, regarding the p-channel transistor, either a drain or a source having a higher potential is referred to as a source. However, in some transistors of the transistors T1 to T7, a relationship of levels of potentials between two terminals other than a gate terminal (a control terminal) is interchanged depending on a condition. For this reason, regarding the transistors T1 to T7, one of the two terminals other than the gate terminal is hereinafter referred to as a “first conduction terminal”, and the other terminal is referred to as a “second conduction terminal”.

The driving transistor T1 includes a gate terminal which is connected with a second conduction terminal of the threshold voltage compensation transistor T2, a first conduction terminal of the initialization transistor T3, and the second electrode of the holding capacitor C1. The driving transistor T1 includes a first conduction terminal which is connected with a second conduction terminal of the writing control transistor T5 and a second conduction terminal of the power supply control transistor T6. The driving transistor T1 includes a second conduction terminal which is connected with a first conduction terminal of the threshold voltage compensation transistor T2 and a first conduction terminal of the light emission control transistor T4. The threshold voltage compensation transistor T2 includes a gate terminal which is connected with a scanning signal line G(n) of the n-th row. The threshold voltage compensation transistor T2 includes the first conduction terminal which is connected with the second conduction terminal of the driving transistor T1 and the first conduction terminal of the light emission control transistor T4. The threshold voltage compensation transistor T2 includes the second conduction terminal which is connected with the gate terminal of the driving transistor T1, the first conduction terminal of the initialization transistor T3, and the second electrode of the holding capacitor C1. The initialization transistor T3 includes a gate terminal which is connected with a scanning signal line G(n−1) of an (n−1)-th row. The initialization transistor T3 includes the first conduction terminal which is connected with the gate terminal of the driving transistor T1, the second conduction terminal of the threshold voltage compensation transistor T2, and the second electrode of the holding capacitor C1. The initialization transistor T3 includes a second conduction terminal which is connected with an initialization power source line. The light emission control transistor T4 includes a gate terminal which is connected with a light emission control line EM(n) of the n-th row. The light emission control transistor T4 includes the first conduction terminal which is connected with the second conduction terminal of the driving transistor T1 and the first conduction terminal of the threshold voltage compensation transistor T2. The light emission control transistor T4 includes a second conduction terminal which is connected with a first conduction terminal of the anode control transistor T7 and an anode terminal of the organic EL element OLED.

The writing control transistor T5 includes a gate terminal which is connected with the scanning signal line G(n) of the n-th row. The writing control transistor T5 includes a first conduction terminal which is connected with a corresponding data line D. The writing control transistor T5 includes the second conduction terminal which is connected with the first conduction terminal of the driving transistor T1 and the second conduction terminal of the power supply control transistor T6. The power supply control transistor T6 includes a gate terminal which is connected with the light emission control line EM(n) of the n-th row. The power supply control transistor T6 includes a first conduction terminal which is connected with a high level power source line and the first electrode of the holding capacitor C1. The power supply control transistor T6 includes the second conduction terminal which is connected with the first conduction terminal of the driving transistor T1 and the second conduction terminal of the writing control transistor T5. The anode control transistor T7 includes a gate terminal which is connected with the scanning signal line G(n) of the n-th row. The anode control transistor T7 includes the first conduction terminal which is connected with the anode terminal of the organic EL element OLED. The anode control transistor T7 includes a second conduction terminal which is connected with the initialization power source line.

The holding capacitor C1 includes the first electrode which is connected with the high level power source line and the first conduction terminal of the power supply control transistor T6. The holding capacitor C1 includes the second electrode which is connected with the gate terminal of the driving transistor T1, the second conduction terminal of the threshold voltage compensation transistor T2, and the first conduction terminal of the initialization transistor T3. The organic EL element OLED includes the anode terminal which is connected with the second conduction terminal of the light emission control transistor T4 and the first conduction terminal of the anode control transistor T7. The organic EL element OLED includes a cathode terminal which is connected with a low level power source line.

### 2.2 Operation of Pixel Circuit

FIG. 4 is a timing chart for describing a driving method of the pixel circuit 10 corresponding to the certain column of the n-th row (the pixel circuit 10 illustrated in FIG. 3). Before time t0, the scanning signal G(n−1) and the scanning signal G(n) are at a high level, and the light emission control signal EM(n) is at a low level. At this time, the light emission control transistor T4 is in an ON state, and the organic EL element OLED emits light according to a magnitude of a drive current.

At time t0, the light emission control signal EM(n) is changed from the low level to the high level. This turns the light emission control transistor T4 and the power supply control transistor T6 to an OFF state. As a result, the supply of the electric current to the organic EL element OLED is cut off, and the organic EL element OLED is turned to a switch-off state.

At time t1, the scanning signal G(n−1) is changed from the high level to the low level. This turns the initialization transistor T3 to an ON state. As a result, a gate voltage of the driving transistor T1 is initialized. In other words, the gate voltage of the driving transistor T1 becomes equal to the initialization voltage Vini.

At time t2, the scanning signal G(n−1) is changed from the low level to the high level. This turns the initialization transistor T3 to an OFF state. At time t3, the scanning signal G(n) is changed from the high level to the low level. This turns the threshold voltage compensation transistor T2, the writing control transistor T5, and the anode control transistor T7 to an ON state. When the anode control transistor T7 is turned to the ON state, an anode voltage of the organic EL element OLED is initialized based on the initialization voltage Vini. When the threshold voltage compensation transistor T2 and the writing control transistor T5 are turned to the ON state, a data signal is applied to the second electrode of the holding capacitor C1 via the writing control transistor T5, the driving transistor T1, and the threshold voltage compensation transistor T2. Consequently, the holding capacitor C1 is charged.

At time t4, the scanning signal G(n) is changed from the low level to the high level. This turns the threshold voltage compensation transistor T2, the writing control transistor T5, and the anode control transistor T7 to an OFF state.

At time t5, the light emission control signal EM(n) is changed from the high level to the low level. This turns the light emission control transistor T4 and the power supply control transistor T6 to an ON state, and a drive current according to the charged voltage of the holding capacitor C1 is supplied to the organic EL element OLED. As a result, the organic EL element OLED emits light according to the magnitude of the drive current. After that, the organic EL element OLED emits light throughout a period until the light emission control signal EM(n) is changed from the low level to the high level at time t10.

### 3. Demultiplexer Portion

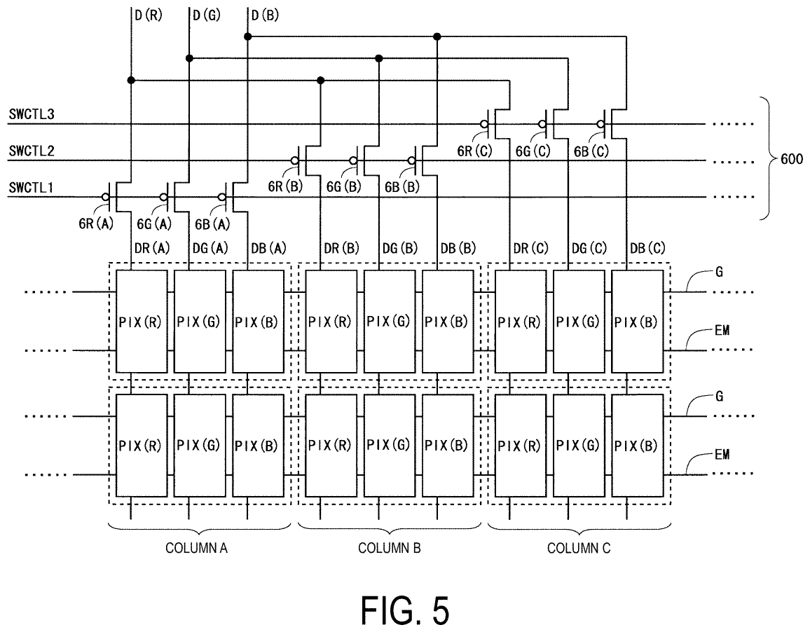

Next, with reference to FIG. 5, a detailed configuration of the demultiplexer portion 600 will be described. In the present embodiment, the demultiplexer portion 600 realizes a data signal distribution portion. Note that FIG. 5 only illustrates a configuration for three columns. Here, for the sake of convenience, the three columns to be focused are referred to as a “column A”, a “column B”, and a “column C”. In FIG. 5, each output line that transmits a data signal for red is designated by a reference sign D(R), each output line that transmits a data signal for green is designated by a reference sign D(G), and each output line that transmits a data signal for blue is designated by a reference sign D(B). Each red subpixel is designated by a reference sign PIX(R), each green subpixel is designated by a reference sign PIX(G), and each blue subpixel is designated by a reference sign PIX(B). For example, a data line connected with the pixel circuit 10 forming the red subpixel of the column B is designated by a reference sign DR(B). Note that one end of the output line D(R), one end of the output line D(G), and one end of the output line D(B) are connected with respective output portions of the source driver 500.

As illustrated in FIG. 5, the demultiplexer portion 600 (for three columns) includes nine switches 6R(A), 6G(A), 6B(A), 6R(B), 6G(B), 6B(B), 6R(C), 6G(C), and 6B(C). The switches 6R(A), 6G(A), and 6B(A) are switches provided to correspond to the column A. The first switch control signal SWCTL1 controls states of the switches 6R(A), 6G(A), and 6B(A). The switches 6R(B), 6G(B), and 6B(B) are switches provided to correspond to the column B. The second switch control signal SWCTL2 controls states of the switches 6R(B), 6G(B), and 6B(B). The switches 6R(C), 6G(C), and 6B(C) are switches provided to correspond to the column C. The third switch control signal SWCTL3 controls states of the switches 6R(C), 6G(C), and 6B(C). Note that in the present embodiment, when the switch control signal is at the low level, a corresponding switch is turned to an ON state.

The data line DR(A) is connected with the output line D(R) via the switch 6R(A), the data line DR(B) is connected with the output line D(R) via the switch 6R(B), and the data line DR(C) is connected with the output line D(R) via the switch 6R(C). The data line DG(A) is connected with the output line D(G) via the switch 6G(A), the data line DG(B) is connected with the output line D(G) via the switch 6G(B), and the data line DG(C) is connected with the output line D(G) via the switch 6G(C). The data line DB(A) is connected with the output line D(B) via the switch 6B(A), the data line DB(B) is connected with the output line D(B) via the switch 6B(B), and the data line DB(C) is connected with the output line D(B) via the switch 6B(C).

As described above, in the present embodiment, each output portion of the source driver 500 is associated with three data lines. Specifically, each output portion of the source driver 500 is associated with three data lines spaced two data lines apart. Each output portion of the source driver 500 is associated with three data lines for supplying data signals to subpixels of the same color. Specifically, three data lines associated with each output portion are connected with three subpixels of the same color. The three subpixels of the same color are included in respective three pixels successively arranged in a direction orthogonal to the data lines (a direction in which the scanning signal lines extend). Further, the demultiplexer portion 600 includes switches. Three switches are provided for each output portion to control a state of electrical connection between each output portion of the source driver 500 and each of the three data lines associated with the output portion. One switch control signal controls states of three switches that control a state of electrical connection between each of three data lines for supplying data signals to respective three subpixels forming each pixel and each of three output lines (three output portions of the source driver 500) associated with the three data lines.

In such a configuration as described above, when the first switch control signal SWCTL1 is at the low level, the switches 6R(A), 6G(A), and 6B(A) are turned to an ON state, and data signals are supplied to the data lines DR(A), DG(A), and DB(A) connected with the pixel circuits 10 forming the subpixels included in the column A. When the second switch control signal SWCTL2 is at the low level, the switches 6R(B), 6G(B), and 6B(B) are turned to an ON state, and data signals are supplied to the data lines DR(B), DG(B), and DB(B) connected with the pixel circuits 10 forming the subpixels included in the column B. When the third switch control signal SWCTL3 is at the low level, the switches 6R(C), 6G(C), and 6B(C) are turned to an ON state, and data signals are supplied to the data lines DR(C), DG(C), and DB(C) connected with the pixel circuits 10 forming the subpixels included in the column C.

### 4. Driving Method

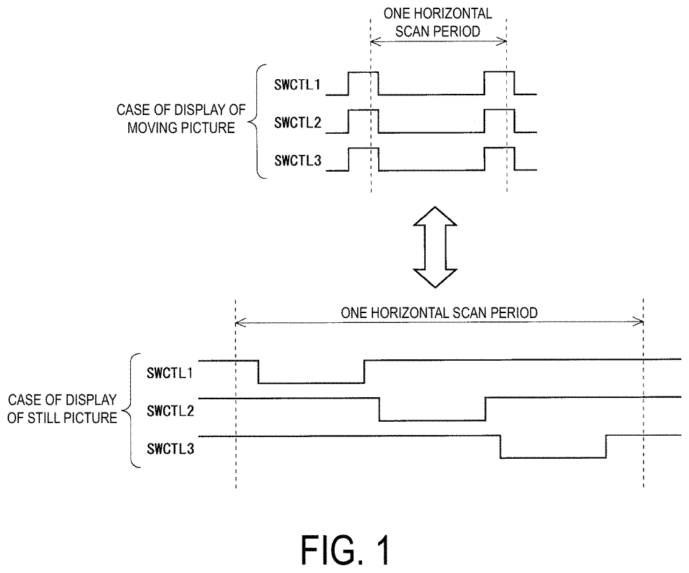

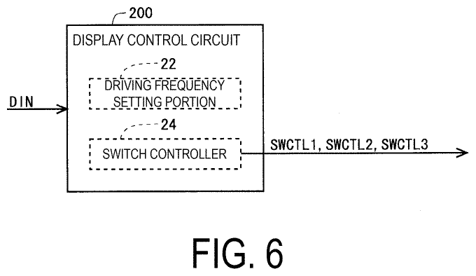

Next, a driving method will be described. FIG. 1 is a diagram for describing an outline of a driving method. In the present embodiment, a length of one horizontal scan period varies between a case of display of a moving picture and a case of display of a still picture. Specifically, the length of one horizontal scan period in the case of display of a still picture is three times as long as the length of one horizontal scan period in the case of display of a moving picture. In other words, a driving frequency in the case of display of a still picture is one third of a driving frequency in the case of display of a moving picture. As illustrated in FIG. 1, the first to third switch control signals SWCTL1 to SWCTL3 are simultaneously turned to the low level in the case that display of a moving picture is performed, whereas the first to third switch control signals SWCTL1 to SWCTL3 are turned to the low level one by one in the case that display of a still picture is performed. In order to implement such control as described above, as illustrated in FIG. 6, the display control circuit 200 includes a driving frequency setting portion 22 configured to set a driving frequency depending on whether an image to be displayed in the display portion 100 is a moving picture or a still picture, and a switch controller 24 configured to control states of the switches included in the demultiplexer portion 600. Note that whether the image to be displayed in the display portion 100 is a moving picture or a still picture is determined based on the input image signal DIN. The driving method according to the present embodiment will be described in detail below.

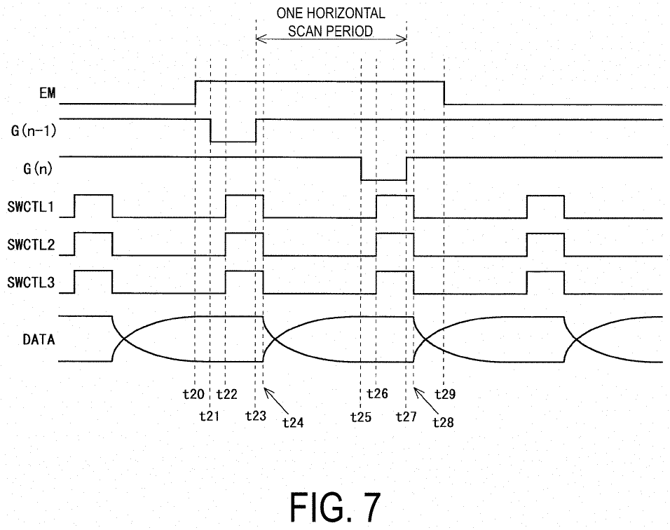

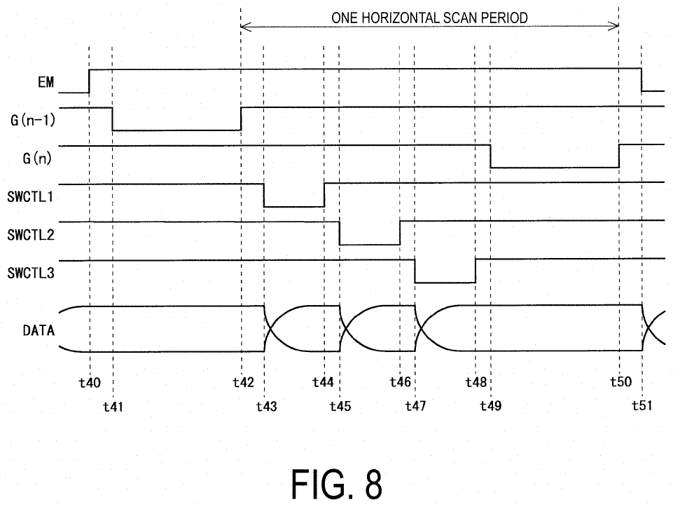

FIG. 7 is a timing chart for describing a driving method in the case of display of a moving picture. Here, the focus is on operation when data signal is written to the holding capacitor C1 in the pixel circuit 10 of the n-th row. In FIG. 7, change in the voltage of the data lines is represented by a waveform designated by “DATA” (the same also applies in FIG. 8).

At time t20, the light emission control signal EM(n) is changed from the low level to the high level. This turns the organic EL element OLED in the pixel circuit 10 of the n-th row to a non-lighting state. At time t21, the scanning signal G(n−1) is changed from the high level to the low level. This initializes a gate voltage of the driving transistor T1 in the pixel circuit 10 of the n-th row. At time t22, the first to third switch control signals SWCTL1 to SWCTL3 are changed from the low level to the high level. This turns all of the switches 6R(A), 6G(A), 6B(A), 6R(B), 6G(B), 6B(B), 6R(C), 6G(C), and 6B(C) in the demultiplexer portion 600 to an OFF state.

At time t23, the scanning signal G(n−1) is changed from the low level to the high level. After that, at time t24, the first to third switch control signals SWCTL1 to SWCTL3 are changed from the high level to the low level. This turns all of the switches 6R(A), 6G(A), 6B(A), 6R(B), 6G(B), 6B(B), 6R(C), 6G(C), and 6B(C) in the demultiplexer portion 600 to an ON state. Consequently, data signals are supplied to all of the data lines from the output lines. Specifically, a data signal for red is supplied from the output line D(R) to the data lines DR(A), DR(B), and DR(C), a data signal for green is supplied from the output line D(G) to the data lines DG(A), DG(B), and DG(C), and a data signal for blue is supplied from the output line D(B) to the data lines DB(A), DB(B), and DB(C).

At time t25, the scanning signal G(n) is changed from the high level to the low level. Consequently, the holding capacitor C1 in the pixel circuit 10 of the n-th row is charged according to the voltage of a corresponding data line. At time t26, the first to third switch control signals SWCTL1 to SWCTL3 are changed from the low level to the high level. This turns all of the switches 6R(A), 6G(A), 6B(A), 6R(B), 6G(B), 6B(B), 6R(C), 6G(C), and 6B(C) in the demultiplexer portion 600 to an OFF state. As a result, the supply of the data signals from the output lines to the data lines is cut off.

At time t27, the scanning signal G(n) is changed from the low level to the high level. This turns the threshold voltage compensation transistor T2, the writing control transistor T5, and the anode control transistor T7 to an OFF state, and the charged voltage of the holding capacitor C1 is determined in the pixel circuit 10 of the n-th row.

At time t28, the first to third switch control signals SWCTL1 to SWCTL3 are changed from the high level to the low level. After that, at time t29, the light emission control signal EM(n) is changed from the high level to the low level. Consequently, in the pixel circuit 10 of the n-th row, a drive current according to the charged voltage of the holding capacitor C1 is supplied to the organic EL element OLED, and the organic EL element OLED emits light according to the magnitude of the drive current.

As described above, in the case that display of a moving picture is performed, three switches corresponding to each output portion of the source driver 500 are simultaneously turned to an ON state in one horizontal scan period. Consequently, regarding each color (each basic color), writing based on data signals having the same signal value is performed in subpixels of three columns that are successively arrayed in a direction in which the scanning signal lines extend.

FIG. 8 is a timing chart for describing a driving method in the case of display of a still picture. Here also, the focus is on operation when data signals are written to the holding capacitor C1 in the pixel circuit 10 of the n-th row.

At time t40, the light emission control signal EM(n) is changed from the low level to the high level. This turns the organic EL element OLED in the pixel circuit 10 of the n-th row to a non-lighting state. At time t41, the scanning signal G(n−1) is changed from the high level to the low level. This initializes a gate voltage of the driving transistor T1 in the pixel circuit 10 of the n-th row.

At time t42, the scanning signal G(n−1) is changed from the low level to the high level. After that, at time t43, the first switch control signal SWCTL1 is changed from the high level to the low level. This turns the switches 6R(A), 6G(A), and 6B(A) in the demultiplexer portion 600 to an ON state. Consequently, data signals are supplied to the data lines corresponding to the column A from the output lines. Specifically, a data signal for red is supplied from the output line D(R) to the data line DR(A), a data signal for green is supplied from the output line D(G) to the data line DG(A), and a data signal for blue is supplied from the output line D(B) to the data line DB(A). At time t44, the first switch control signal SWCTL1 is changed from the low level to the high level. This turns the switches 6R(A), 6G(A), and 6B(A) in the demultiplexer portion 600 to an OFF state. As a result, the supply of the data signals from the output lines to the data lines is cut off.

At time t45, the second switch control signal SWCTL2 is changed from the high level to the low level. This turns the switches 6R(B), 6G(B), and 6B(B) in the demultiplexer portion 600 to an ON state. Consequently, data signals are supplied to the data lines corresponding to the column B from the output lines. Specifically, a data signal for red is supplied from the output line D(R) to the data line DR(B), a data signal for green is supplied from the output line D(G) to the data line DG(B), and a data signal for blue is supplied from the output line D(B) to the data line DB(B). At time t46, the second switch control signal SWCTL2 is changed from the low level to the high level. This turns the switches 6R(B), 6G(B), and 6B(B) in the demultiplexer portion 600 to an OFF state. As a result, the supply of the data signals from the output lines to the data lines is cut off.

At time t47, the third switch control signal SWCTL3 is changed from the high level to the low level. This turns the switches 6R(C), 6G(C), and 6B(C) in the demultiplexer portion 600 to an ON state. Consequently, data signals are supplied to the data lines corresponding to the column C from the output lines. Specifically, a data signal for red is supplied from the output line D(R) to the data line DR(C), a data signal for green is supplied from the output line D(G) to the data line DG(C), and a data signal for blue is supplied from the output line D(B) to the data line DB(C). At time t48, the third switch control signal SWCTL3 is changed from the low level to the high level. This turns the switches 6R(C), 6G(C), and 6B(C) in the demultiplexer portion 600 to an OFF state. As a result, the supply of the data signals from the output lines to the data lines is cut off.

At time t49, the scanning signal G(n) is changed from the high level to the low level. Consequently, the holding capacitor C1 in the pixel circuit 10 of the n-th row is charged according to the voltage of a corresponding data line. At time t50, the scanning signal G(n) is changed from the low level to the high level. This turns the threshold voltage compensation transistor T2, the writing control transistor T5, and the anode control transistor T7 to an OFF state, and the charged voltage of the holding capacitor C1 is determined in the pixel circuit 10 of the n-th row.

At time t51, the light emission control signal EM(n) is changed from the high level to the low level. Consequently, in the pixel circuit 10 of the n-th row, a drive current according to the charged voltage of the holding capacitor C1 is supplied to the organic EL element OLED, and the organic EL element OLED emits light according to the magnitude of the drive current.

As described above, in the case that display of a still picture is performed, three switches corresponding to each output portion of the source driver 500 are sequentially turned to an ON state one by one in one horizontal scan period. Consequently, regarding each color (each basic color), with the focus on subpixels of three columns that are successively arrayed in a direction in which the scanning signal lines extend, writing based on data signals having signal values different from each other can be performed in those three subpixels.

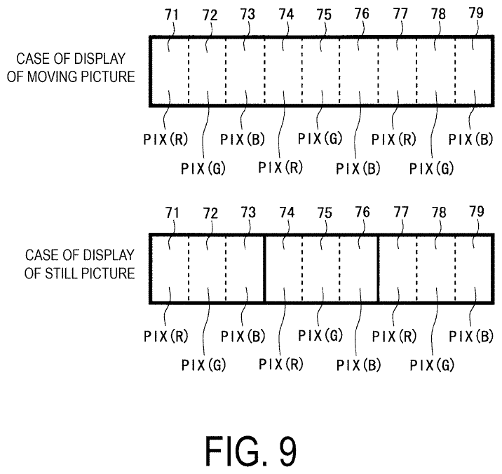

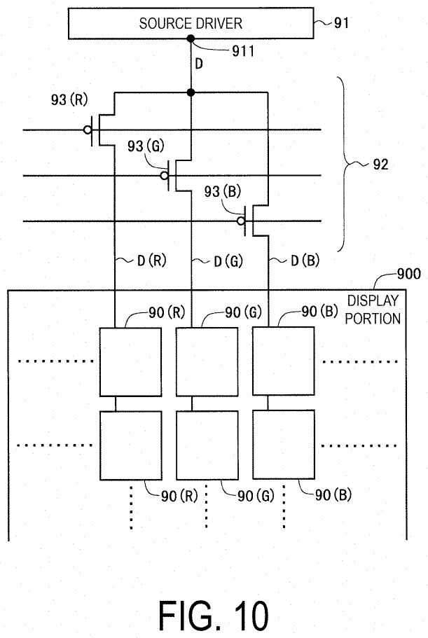

Incidentally, such a driving method as described above is adopted, and thus a resolution of a display image is different between the case of display of a moving picture and the case of display of a still picture. Such a difference in resolutions will be described with reference to FIG. 9. Note that in FIG. 9, the focus is on subpixels for one row that correspond to one output line group (i.e., nine subpixels). Those nine subpixels are designated by reference signs 71 to 79.

In the case of display of a moving picture, through implementation of the above-mentioned driving method, writing based on data signals having the same signal value is performed in three subpixels corresponding to each output line (subpixels of the same color). For this reason, display having the same gray scale is performed in the subpixels 71, 74, and 77, for example. Consequently, the same color is displayed in a pixel including the subpixels 71 to 73, a pixel including the subpixels 74 to 76, and a pixel including the subpixels 77 to 79. As a result, display of colors is performed while one pixel substantially includes nine subpixels 71 to 79 (in FIG. 9, one substantial pixel is represented by a bold frame). In other words, image display is performed with a resolution that is one third of the original resolution. Note that, regarding the manner in which writing based on data signals having the same signal value is performed in three subpixels, for example, the signal value to be used may be a signal value that corresponds to a specific subpixel among the three subpixels, or may be a mean value of signal values that respectively correspond to the three subpixels.

In contrast, in the case of display of a still picture, through implementation of the above-mentioned driving method, writing based on data signals having different signal values is performed in three subpixels corresponding to each output line (subpixels of the same color) (it should be noted that writing based on data signals having the same signal value may be performed depending on a target display image). For this reason, display having different gray scales is performed in the subpixels 71, 74, and 77, for example. Consequently, display of different colors is performed in the pixel including the subpixels 71 to 73, the pixel including the subpixels 74 to 76, and the pixel including the subpixels 77 to 79. In other words, image display is performed with the original resolution.

As described above, in the present embodiment, image display is performed with a resolution that is one third of the original resolution in the case of display of a moving picture, whereas image display is performed with the original resolution in the case of display of a still picture. To be more specific, the resolution in a direction parallel to the data lines is the same between the case of display of a still picture and the case of display of a moving picture. However, the resolution in a direction orthogonal to the data lines (a direction in which the scanning signal lines extend) in the case of display of a still picture is three times as high as that in the case of display of a moving picture.

Note that the above description is based on the premise that the scanning signal lines are sequentially driven one by one, but this is not restrictive. Three scanning signal lines may be driven at a time in the case of display of a moving picture. In other words, in the case of display of a moving picture, the gate driver 300 may output scanning signals of the high level (ON level) at the same timing to three scanning signal lines that are successively provided in a direction in which the data lines extend. Consequently, in the case of display of a moving picture, the resolution is one third of the original resolution (one third of the resolution in the case of display of a still picture) not only in the direction parallel to the data lines but also in the direction orthogonal to the data lines.

### 5. Effects

According to the present embodiment, in the organic EL display device adopting the SSD method, the driving frequency and the operation of the switches in the demultiplexer portion 600 are different between the case that display of a moving picture is performed and the case that display of a still picture is performed. To be more specific, in the case that display of a moving picture is performed, the driving frequency is set to a frequency higher than the driving frequency in the case that display of a still picture is performed, and three switches corresponding to each output portion of the source driver 500 are simultaneously turned to an ON state in each horizontal scan period. In this way, three switches corresponding to each output portion are simultaneously turned to an ON state in each horizontal scan period, instead of being sequentially turned to an ON state in each horizontal scan period. Accordingly, although the resolution is lowered, charge time for each data line is sufficiently secured even with a high driving frequency. In the case that display of a still picture is performed, the driving frequency is set to a frequency lower than the driving frequency in the case that display of a moving picture is performed, and three switches corresponding to each output portion of the source driver 500 are sequentially turned to an ON state at predetermined intervals. Since the driving frequency is set to be low as described above, charge time for each data line is sufficiently secured even when three data lines corresponding to each output portion are sequentially charged in each horizontal scan period. As described above, charge time for each data line is sufficiently secured both in the case that display of a moving picture is performed and the case that display of a still picture is performed. As a result, reduction in display quality due to insufficient charge is suppressed.

### 6. Additional Remarks

Although the above embodiment is described using an example of an organic EL display device, types of display devices are not particularly limited. In display devices including display elements whose luminance or transmittance is controlled by an electric current, the disclosure can also be applied to an inorganic EL display device including inorganic light emitting diodes, a Quantum dot Light Emitting Diode (QLED) display device including QLEDs, and the like. The disclosure can also be applied to display devices including display elements other than the display elements whose luminance or transmittance is controlled by an electric current (e.g., a liquid crystal display device).

Although the above embodiment describes an example in which three primary colors (red, green, and blue) are used as basic colors, the disclosure is not limited thereto. For example, the disclosure can also be applied to a case that four colors (red, green, blue, and white) are used as basic colors, such as in a case where each pixel includes a red subpixel, a green subpixel, a blue subpixel, and a white subpixel. Regarding this respect, a configuration in which each pixel includes K subpixels of basic colors can be adopted, where K represents an integer equal to or greater than 3. In this case, each output portion of the source driver 500 is associated with K data lines.

### REFERENCE SIGNS LIST

6R(A), 6G(A), 6B(A), 6R(B), 6G(B), 6B(B), 6R(C), 6G(C), 6B(C) Switch (in demultiplexer portion)
10 Pixel circuit
22 Driving frequency setting portion
24 Switch controller
100 Display portion
200 Display control circuit
500 Source driver (data line drive circuit)
600 Demultiplexer portion
D(1) to D(i) Output line (from source driver)
DR(1) to DR(i), DG(1) to DG(i), DB(1) to DB(i) Data line
SWCTL1 to SWCTL3 First to third switch control signal
T1 Driving transistor
T2 Threshold voltage compensation transistor
T3 Initialization transistor
T4 Light emission control transistor
T5 Writing control transistor
T6 Power supply control transistor
T7 Anode control transistor

1. A display device including a display portion including multiple pixels, each of the multiple pixels including K (K being an integer equal to or greater than 3) subpixels of basic colors, the display device comprising:
multiple data lines arranged in the display portion, the multiple data lines being configured to supply data signals to the subpixels;
a data line drive circuit configured to drive the multiple data lines by outputting the data signals;
a data signal distribution portion including switches, K switches of the switches being provided for each of output portions of the data line drive circuit, the K switches being configured to control a state of electrical connection between each of the output portions and each of K data lines of the multiple data lines associated with each of the output portions, each of the output portions of the data line drive circuit being associated with the K data lines to enable each of the data signals output from the data line drive circuit to be distributed to the K data lines;
a switch controller configured to control states of the switches included in the data signal distribution portion; and
a driving frequency setting portion configured to set a driving frequency depending on whether an image to be displayed in the display portion is a moving picture or a still picture,
wherein, in a case where the image to be displayed in the display portion is a still picture, the driving frequency setting portion sets the driving frequency to a frequency lower than a frequency when the image to be displayed in the display portion is a moving picture,
the switch controller
simultaneously turns the K switches to an ON state in each of horizontal scan periods in a case where the image to be displayed in the display portion is a moving picture, and
sequentially turns the K switches to an ON state at predetermined intervals in each of the horizontal scan periods in the case where the image to be displayed in the display portion is a still picture.

2. The display device according to claim 1,
wherein the driving frequency set by the driving frequency setting portion in the case where the image to be displayed in the display portion is a still picture is one K-th of the driving frequency set by the driving frequency setting portion in the case where the image to be displayed in the display portion is a moving picture.

3. The display device according to claim 1,
wherein each of the output portions of the data line drive circuit is associated with the K data lines configured to supply the data signals to the subpixels of the same basic color.

4. The display device according to claim 3,
wherein the K data lines associated with each of the output portions of the data line drive circuit are connected with the K subpixels of the same basic color, the K subpixels being included in respective K pixels of the multiple pixels successively arranged in a direction orthogonal to the multiple data lines.

5. The display device according to claim 3,
wherein each of the output portions of the data line drive circuit is associated with the K data lines spaced (K−1) data lines apart.

6. The display device according to claim 1,
wherein one control signal controls states of K switches, the K switches controlling a state of electrical connection between the K data lines and K output portions of the output portions of the data line drive circuit, the K data lines being configured to supply the data signals to the K subpixels included in each of the multiple pixels, the K output portions being associated with the K data lines.

7. The display device according to claim 1, further comprising:
multiple scanning signal lines arranged in the display portion and extending in a direction orthogonal to the multiple data lines, and the multiple scanning signal lines being configured to supply scanning signals to the subpixels; and
a scanning signal line drive circuit configured to drive the multiple scanning signal lines by outputting the scanning signals,
wherein, in the case where the image to be displayed in the display portion is a moving picture, the scanning signal line drive circuit outputs the scanning signals of an ON level to K scanning signal lines of the multiple scanning signal lines at the same timing in each of the horizontal scan periods, the K scanning signal lines being successively provided in a direction in which the multiple data lines extend.

8. The display device according to claim 1,
wherein a resolution in a direction orthogonal to the multiple data lines when the image to be displayed in the display portion is a still picture is K times as high as a resolution in the direction orthogonal to the multiple data lines when the image to be displayed in the display portion is a moving picture, and
a resolution in a direction parallel to the multiple data lines when the image to be displayed in the display portion is a still picture is the same as a resolution in the direction parallel to the multiple data lines when the image to be displayed in the display portion is a moving picture.

9. The display device according to claim 1,
wherein a pixel circuit forming each of the subpixels includes a display element and a capacitance element, the display element being driven by an electric current, the capacitance element being charged according to a data signal of the data signals being supplied to a corresponding data line of the multiple data lines to control an amount of the electric current to be supplied to the display element.

10-11. (canceled)

12. A drive method of a display device including a display portion including multiple pixels, each of the multiple pixels including K (K being an integer equal to or greater than 3) subpixels of basic colors, the display device including:
multiple data lines arranged in the display portion, the multiple data lines being configured to supply data signals to the subpixels;
a data line drive circuit configured to drive the multiple data lines by outputting the data signals; and
a data signal distribution portion including switches, K switches of the switches being provided for each of output portions of the data line drive circuit, the K switches being configured to control a state of electrical connection between each of the output portions and each of K data lines of the multiple data lines associated with each of the output portions, each of the output portions of the data line drive circuit being associated with the K data lines to enable each of the data signals output from the data line drive circuit to be distributed to the K data lines, the driving method comprising:
a driving frequency setting step for setting a driving frequency depending on whether an image to be displayed in the display portion is a moving picture or a still picture; and
a switch controlling step for controlling states of the switches included in the data signal distribution portion,
wherein, in the driving frequency setting step, in a case where the image to be displayed in the display portion is a still picture, the driving frequency is set to a frequency lower than a frequency when the image to be displayed in the display portion is a moving picture,
in the switch controlling step,
in a case where the image to be displayed in the display portion is a moving picture, the K switches are simultaneously turned to an ON state in each of horizontal scan periods, and
in the case where the image to be displayed in the display portion is a still picture, the K switches are sequentially turned to an ON state at predetermined intervals in each of the horizontal scan periods.
